(19) United States
(12) Patent Application Publication
(10) Pub. No.: US 2010/0088138 A1
(43) Pub. Date: Apr. 8, 2010

(54) METHOD AND SYSTEM FOR INTEGRATED SHORT-TERM ACTIVITY RESOURCE STAFFING LEVELS AND LONG-TERM RESOURCE ACTION PLANNING FOR A PORTFOLIO OF SERVICES PROJECTS

(75) Inventors: Lianjun An, Yorktown Heights, NY (US); Dharmashankar Subramanian, Tarrytown, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: International Business Machines Corporation, Armonk, NY (US)

(21) Appl. No.: 12/246,849

(22) Filed: Oct. 7, 2008

(51) Int. Cl. G06Q 10/00

(52) U.S. Cl. 705/8

(57) ABSTRACT

An integrated method for achieving short-term activity resource staffing levels and long-term resource action planning for a portfolio of services projects is presented. The method establishes the short-term resource-staffing level for each project activity in a portfolio of services projects, subject to short-term resource availability in each skill type and substitutability among skill types. It further establishes the long-term resource-staffing level and long-term resource action planning using combination of a plurality of resource actions that include hiring, contracting, and cross-training of skill types.

### CROSS-REFERENCE TO RELATED APPLICATIONS

The present application is related to co-owned and co-pending U.S. patent application Ser. No. 12/015,203, filed on Jan. 16, 2008 and entitled, “Method and System for Planning of Services Workforce Staffing Using Hiring, Contracting and Cross-Training”. That application is incorporated herein by reference in its entirety.

### FIELD OF THE INVENTION

The present disclosure relates generally to resource management, and particularly to integrated short-term activity resource staffing levels and long-term resource action planning for a portfolio of services projects.

### BACKGROUND OF THE INVENTION

In a portfolio of services projects, each project manager delivers a set of resource requests to a resource deployment manager (RDM). This request is in the form of a network of activities, where each activity can be staffed at multiple levels of resource-staffing using various skill-types. Each level implies a specific duration for the activity and hence the project. In the short-term, the RDM needs to decide the level of staffing for each immediate activity, within each project request, subject to short-term resource availability constraints in each skill type. In the longer-term, the RDM needs to decide the level of staffing for each corresponding activity, within each project request, while also exercising the following options: option of cross-training a chosen number of resources from any primary skill type into secondary skills, tertiary skills, and so on; option of further hiring and increasing the system availability of any chosen skill type; option of contracting out a required amount of any chosen skill type. Existing solutions do not consider an integrated approach for incorporating project requests with short-term resource-staffing, long-term resource-action planning and resource-staffing levels for various activities.

Mathematical programming techniques have been used to address the time-tabling problem to generate personal schedules in call centers, nurse scheduling, air crew roistering, bus- and train-driver scheduling, etc. The literature on the use of optimization techniques to the resource allocation and the resource action planning problem for the services business is much less in comparison. Skill allocation using constraint programming is presented in D. L. Gresh, D. P. Connors, J. P. Fasano and R. J. Wittrock, “Applying Supply Chain Optimization Techniques to Workforce Planning Problems”, IBM J. Res. & Dev., vol. 51, pp. 251-261, 2007. Supply-chain techniques have also been used to analyze the shortage and overage situation in workforce with multiple skills over a corresponding time-horizon. However, the problem of integrated short-term resource staffing and longer-term resource action planning for effective management of an engagement portfolio has not been addressed in the literature.

### BRIEF SUMMARY OF THE INVENTION

A method and system for integrated short-term activity resource staffing levels and long-term resource action planning for a portfolio of services projects are provided. The method, in one aspect, may comprise establishing short-term resource-staffing level for each project activity in a portfolio of services projects subject to short-term resource availability in each skill type and substitutability among skill types. The method may farther include establishing long-term resource-staffing level and establishing long-term resource action planning to meet the long-term resource-staffing level using combination of a plurality of resource actions.

A system for integrated short-term activity resource staffing levels and long-term resource action planning for a portfolio of services projects, in one aspect, may comprise a computer-implemented resource-staffing module operable to establish a short-term resource-staffing level for each project activity in a portfolio of services projects subject to short-term resource availability in each skill type and substitutability among skill types and further operable to establish a long-term resource-staffing level. A computer-implemented resource action planning module is operable to establish long-term resource action planning to meet the long-term resource-staffing level using a combination of a plurality of resource actions.

A program storage device readable by a machine, tangibly embodying a program of instructions executable by the machine to perform a method for integrated short-term activity resource staffing levels and long-term resource action planning for a portfolio of services projects may be also provided.

### BRIEF DESCRIPTION OF THE DRAWINGS

FIG. 1 shows functional components of the integrated model of the present disclosure in one embodiment.

FIG. 2 is a flow diagram illustrating a method of allocating resources using the above described optimization model.

### DETAILED DESCRIPTION

In a services business, potential engagements or services projects materialize from business development and sales efforts. Each engagement is unique with respect to the nature of the solution, the specific set of project activities and resource requirements, and the duration of the time-frame spanned by the project. For example, consider a three-month risk analysis consulting project versus a two-year enterprise resource planning (ERP) software and applications deployment project. The workforce capacity and resource planning of various skill types should be dynamically managed depending on the nature and scope of the various projects in the engagement pipeline.

When a potential opportunity leads to a signed contract, the engagement manager prepares a resource request that gets delivered to a resource deployment manager. A general request is in the form of a network of activities, where each activity can be staffed at potentially multiple levels of resource-staffing using various skill types. Each level of staffing implies a specific duration for the activity and, hence, the project. Depending on the nature of the engagement and the duration spanned by its project activity network, individual activities may either require immediate, short-term resource staffing, or require a longer-term plan with respect to the resource staffing level. Short-term resource staffing decisions at chosen levels need to respect the corresponding availability of resources in each skill type. Similarly, decisions about the longer-term plan for resource staffing levels of later activities need to be taken, and further translated into a specific resource action plan. A resource action plan takes the form of some combination of specific hiring, contracting, or cross-training decisions over the longer-term horizon. This is so that the company is well-positioned to execute on its longer-term resource staffing plan for each engagement.

In the case that several potential engagement opportunities come to fruition, a company needs enough workers to cover all the projects to prevent missed opportunities. At the same time, it is undesirable to have extra personnel sitting on the bench with a low utilization rate. In practice, a company may choose to contract a certain number of workers with chosen skill types for a short duration to fulfill some activities at a potentially higher cost. Also, a company may choose to cross-train employees to impart multiple skills. Some workers would then be available for cross-skill transfers if a shortage does not happen in all skills at the same time. There is some degree of flexibility in practice in that each contracted engagement may have some slack time with respect to start and finish time requirements, along with staffing-level dependent activity duration for some inherently parallelizable activities. It is indeed possible that different engagement projects and their activities can be staffed in different time-slots at different levels, without affecting the overall engagement portfolio with respect to resource availability. A system and method of the present disclosure attempt to address all these issues through optimal management policies in order to meet demand effectively by exploiting these possible flexibilities.

Firstly, activity duration that depends on the level of resource-staffing provides a distinct flexibility with respect to dynamic management of a workforce. This is true specifically for activities that have an inherently parallelizable nature. How do we exploit this flexibility to address the short-term staffing decisions, longer-term planned staffing decisions and the specific resource action plan that is necessary to execute the longer-term staffing plan? Can we meet the short-term staffing requirement under some substitutability in current available skills?

Secondly, specific resource actions like hiring, contracting or cross-training are out of picture for the short-term staffing decisions for immediate activities due to lead-time constraints. Thirdly, staffing level decisions need to be made for resource assignment to activities that are not immediate, and these decisions need to be further translated into a specific resource action plan in terms of hiring, contracting, or cross-training to be able execute the longer-term plan. The resource action plan needs to respect multiple operational constraints and business rules, such as, the training cost and lead time, the minimal residence time that a resource-unit needs to spend in any skill type upon being cross-trained or hired into, minimal acceptable duration for any contracted skill type, and the stochastic nature associated with any potential opportunity that has not resulted in a signed contract.

Due to the flexibility resulting from multiple staffing levels in each engagement, as well as staffing-level dependent activity duration, the aggregated resource requirement can be different under different long-term plans for staffing-levels in various engagements. The system and method of the present disclosure in one embodiment integrate project management with workforce management. Each project manager or like presents an activity network, along with potentially multiple staffing levels of skills associated with each activity. The resource deployment manager (RDM) or like exploits the flexibility on staffing-levels based on such requests from multiple projects. The system and method of the present disclosure in one embodiment also apply an integrated approach to address short-term resource level staffing and long-term resource action planning.

An integrated method and system of the present disclosure in one embodiment address both the immediate short term staffing level, and the planned, long term staffing level for a portfolio of requests using two-time-scale optimization formulation. In the short-term, the level of staffing for each immediate activity is decided for each project request, subject to short-term resource availability in each skill type and substitutability among skill types. In the long-term, a planned level of staffing for each of the corresponding activities within each project request is decided, to farther carry out a resource action planning exercise. The resource action considers regular hiring, contracting and cross-training among skill types.

The long-term resource action planning model in one embodiment allows hiring, cross-training and contracting to fulfill incoming engagement projects. Further, it allows for the following operational considerations: minimum residence time that any resource unit needs to spend in any skill-type that it gets cross-trained into, or hired into; minimum acceptable contracting duration for any contracted skill type; first order and higher orders of cross-training for any skill type, with lead-time that is necessary for training; system rules on permissible transfers; targets on service levels and resource utilization. The long-term resource action planning model also may consider multiple objectives such as gap minimization, glut minimization, cost minimization with demand fulfillment constraints, and weighted combinations of the above. It also takes into consideration a stochastic extension for a risk-measure on gap, or glut, due to uncertainties in the demand profile.

In one embodiment, an integrated model uses two time scales, one for the short-term resource staffing for immediate activities, and another for planning the longer-term staffing-level for non-immediate activities across various engagements. Both scales take advantage of the flexibilities in each project. The longer-term staffing-level plan implies an aggregated resource requirement outlook, which is taken as an input into a resource action planning model.

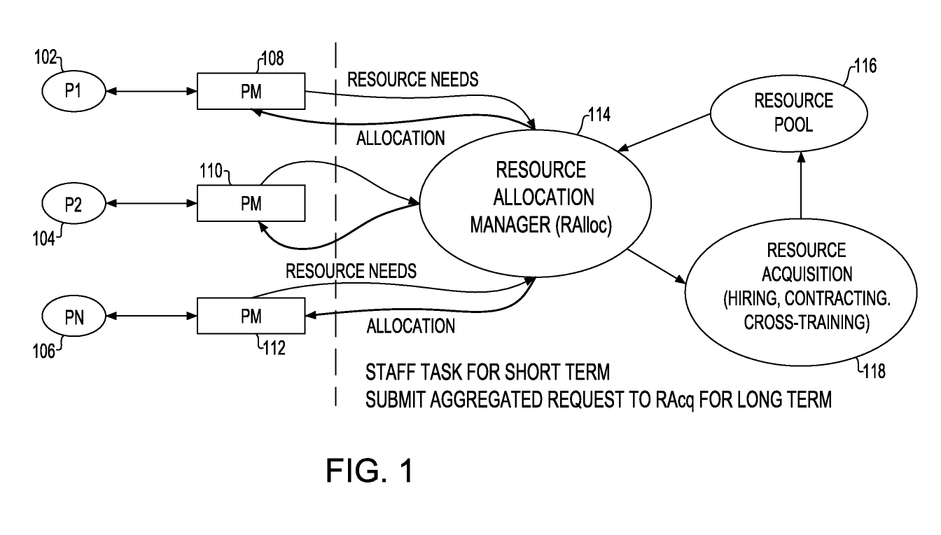

FIG. 1 shows functional components of the integrated model of the present disclosure in one embodiment. The functional components may be implemented as computer-implemented hardware, software, or firmware or like. Multiple projects (e.g., P1, P2, P3) 102, 104, 106 are input with activity network detail. Each project maybe managed by a project manager who wants to optimize his project plan locally, for example. A computer-implemented project manager module (PM) 108, 110, 112 may be implemented to automate or aid in the process of submitting resource requests and associated information for projects. Each PM 108, 110, 112 submits resource needs to a resource allocation manager module or like 114. The resource allocation manager module 114 (also referred to as RDM module) allocates resources to each project based on the availability of different skill types that are recorded in the skill pool 116, over the short term, while also exploiting substitutability among skill types. The skill pool 116 maintains the information of all resources, including count of each skill type, hiring and cross-training and contracting history, and experience level. The substitutability among skill types may result from cross-training history. After assigning skill-type units (personnel) to multiple activities in the short-term, the skill pool will be updated for availability of such skills. The resource acquisition 118 is responsible to get the aggregated resource request for multiple skill types for long term from the RDM 114 and to compare available resource in that period, with the goal of identifying/executing an optimal resource action plan. The optimal resource action plan is captured in terms of decisions pertaining to hiring, cross-training and contracting appropriate numbers of resource skill-types at various points in time in the planning horizon.

Each resource request may be in terms of multiple levels of staffing using various skill types, for each activity, within each project that encodes a precedence structure over the activities that make up the project. Each level of staffing for any activity corresponds to distinct activity duration. Further a short-term time-scale parameter and a long-term time-scale planning horizon length are given.

RA or RDM 114, for example, or like takes the resource request related to each project activity and uses a two-scale model to staff the immediate (short-term) activities with an optimal staffing level subject to resource availability constraints, and to plan for the optimal staffing-levels of the long-term activities across the entire portfolio of engagements. The resulting long-term plan for staffing levels of the farther out activities implies an aggregated resource requirement outlook for each of the skill-types. Aggregated resource requirement refers to aggregation or, summation (sum-up) of the requested amount of the same skill type across all activities that would occur at the same future period. Resource Acquisition Manager (RAM) 118 may not be aware of individual activity requirement and project structure. RDM 114 aggregates resource requirement for all projects for each skill type and presents this information to RAM 118. RAM 118 is a planning model that seeks to develop an optimal resource action plan corresponding to the aggregated resource requirement of each skill-type, in each forward-looking time period in the planning horizon. The Resource Acquisition Manager (RAM) 118, for example, or like takes this aggregated requirement as input, compares with the available skill pool 116, and uses a mathematical model to create an optimal resource action plan for hiring, contracting and cross-training skills. An example of a mathematical model that can be used to create an optimal resource action plan is described in D. Subramanian and L. An, “Optimal Resource Action Planning Analytics for Services Business Using Hiring, Contracting and Cross-Training of Various Skills”, 2008 IEEE International Conference on Services Computing (SCC 2008), Honolulu, Hi., July, 2008, the entire contents of which are incorporated herein by reference.

The model provides the level of resource-staffing for each activity in each project over the short-term time-scale (used to assign skill-type units (e.g., personnel) right away), the level of resource-staffing for each activity in each project over the long-term time-scale (which in turn, implies the requirement for different skill types in different time periods, when aggregated across all projects/activities), while also deciding on resource-acting planning using the following control actions, for example: hire, contract, or cross-train between skill types, each with its own cost structure. The model may use the following constraints for the short-term time-scale: availability of resources of each skill-type, precedence structure within each project, and earliest start and latest finish constraints for each project. The model may also use the following constraints on the long-term time scale: availability of resources of each skill-type; precedence structure within each project, and earliest start/latest finish constraints for each project. The following operational constraints are also used by the model: cross-training lead-times and costs on allowable pairs of skills, minimum residence time in any skill set, minimum acceptable contract duration, rules on allowable transfers. The model minimizes the total cost resulting from accumulated gaps and gluts for each skill type, and hiring, contracting and cross-training costs, using an optimal sequence of choices of control actions. Using the solutions provided by the model, resource allocation manager 114 allocates resources to each project in the short-term, and creates an aggregated view of resource requirement on all skill types in the long-term. Using the solutions provided by the model, the resource acquisition manager 118 can hire and/or contract some skill types, and/or cross-train some skill types, and make one or more transfers from one skill type to another, or make one or more skill types ready for substitution during skill assignment. The outlook of skill pool 116 will be changed as a result of execution of resource actions.

### Project Flexibility

In one embodiment, there are two kinds of flexibilities that may be specified for each project. Multiple staffing levels may be specified for each activity in the project. An overall schedule constraint in terms of earliest start, latest start and latest finish may be specified for each project. Each project has a network of activities, whose dependency can be specified through a predecessor-successor relationship. As a result of the precedence network, some activities might have an inherent slack with respect to their start times without impacting the duration of the project, while other activities on critical paths of the project may not have any slack as per standard techniques in project management.

The flexibility with staffing-level dependent activity duration is that an activity, which is originally not on the critical path for one staffing-level scenario, say the nominal staffing level, can be on the critical path for another staffing level. A project would take longer to finish when activities on the critical oaths in a nominal staffing level are staffed at a lower-than-nominal level. But note that it is okay to staff activities at any chosen lower level, when the activities are not on the nominal critical paths, if they continue to remain non-critical at the chosen lower level of staffing. That an activity is critical means that the project duration, where a project is a networked sequence of activities, critically depends on the start-time and finish time of the critical activity. Any slippage and/or delay in the critical activities will lead to slippage and/or delay in the finish of the project. In one aspect, the earliest start and latest start time for the critical activity are the same. Similarly, the earliest finish and latest finish for the critical activity are the same. If the activity is delayed, then the whole project will be delayed. In contrast, an activity that is not critical has slack time. As long as the actual start time is between the earliest start time and latest start time, the duration of the whole project would not be affected. In our context of choosing different staffing levels for any activity and/or project, the duration of an activity can be changed. So, it is possible that an activity, that is not critical in a high staffing level, could become critical in a low staffing level.

### Short-Term Staffing

In the short-term time scale, it is generally not possible to hire, contract or cross-train employees to meet demand. Here it is assumed that there is some flexibility in current available workforce pool in terms of skills substitutability. Note that the substitutability might have resulted from the cross-training control actions taken as part of previous long-term resource actions. The short-term time scale addresses the short-term resource staffing level for each activity within each project request, subject to, for instance, schedule constraint from each project (earliest start (“ES”), latest start (“LS”), latest finish (“LF”)); resource availability in each skill type; substitutability among skill types; staffing-level continuity for activities that start in the short-term time-scale and extend beyond the short-term horizon.

When there is a shortage situation, some activities may be staffed at a lower level, and some projects may start somewhat later in time within their admissible time frame. When there is an overage situation, some activities should be staffed in a higher level in order to achieve a higher utilization rate and some projects could potentially start as early as possible.

### Long-Term Staffing-Level Plan and Resource Action Planning

The long-term time scale is used to address both the long-term resource staffing level for each activity within each project request and the optimal long-term resource action planning. The long-term resource action planning model allows hiring, cross-training and contracting with corresponding costs. It allows for several operational and business constraints. There are two mathematical models that are involved in the integrated bi-scale model setting. The first model spans both the short-term and the long-term time scale to decide the short-term staffing level for immediate activities, as well as plan the long-term staffing levels for farther out activities. The model decides which activities are included in the short-term and which activities get planned into the long-term. The second model spans the long-term time scale to develop a specific resource action plan that addresses the long-term resource outlook aggregated by skill-type, which is implied by the long-term staffing-level decisions made in the first model.

The system and method of the present disclosure in one embodiment use a decomposition approach that separates resource-staffing level optimization problem and optimal resource-action planning problem. In one embodiment, the resource staffing level problem decides the level of resource-staffing that needs to be allocated to each activity, within each project. It spans both the short-term time-scale and the long-term time-scale and imposes a hard resource constraint, based on current availability of resources in each skill type, only for those activities that start within the short-term time-scale. This resource staffing level problem implies a demand profile for each skill type over the long-term time-scale. To meet the implied demand, the resource-action planning problem addresses workforce planning with operational constraints which affect the plan optimality: minimum residence time that any resource unit needs to spend in any skill type that it gets cross-trained into, or hired into; minimum acceptable contracting duration for any contracted skill type; first order and higher orders of cross-training for any skill type, with lead-time and cost that is necessary for training; system rules on permissible transfer sequences; targets on service levels and resource utilization under the above set of constraints.

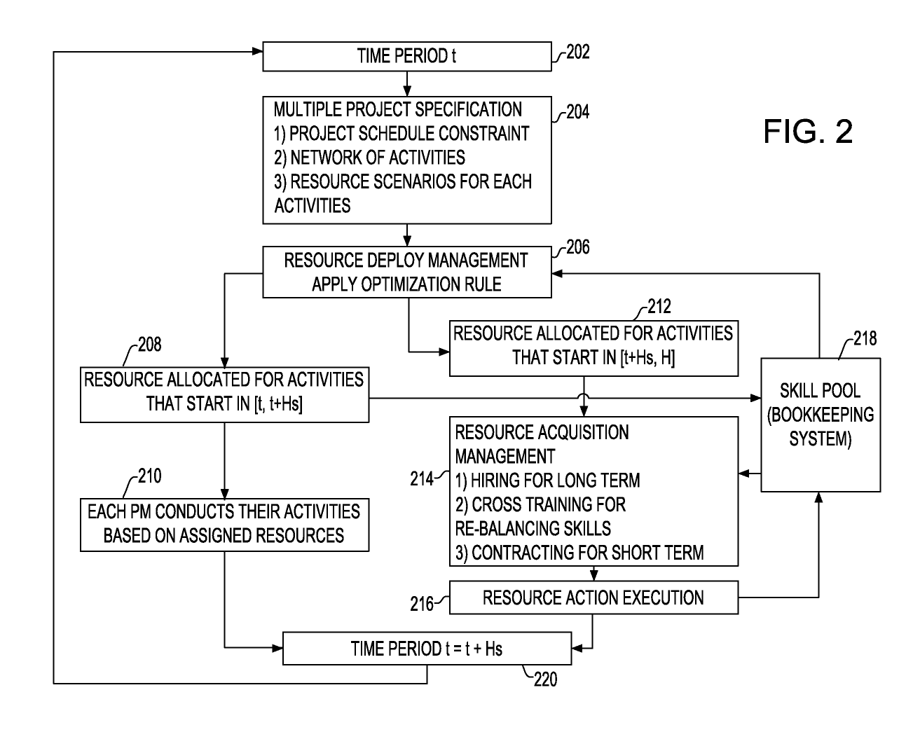

FIG. 2 is a flow diagram illustrating a method of allocating resources using the above described optimization model. At time period (t) shown at 202, project managers specify early and late start for one or more projects and one or more dependencies among activities and resource scenarios associated to each activity (e.g., different staffing level and the corresponding duration) as shown at 204. Specification about projects and activities may include multiple projects, possible dependencies among the projects, early and late start, late finish for each project. Activity dependencies may specify, for example, that task C of project 1 depends on completion of task B of project 1; task D of project 1 depends on completion of task A and task C; task E of project 1 depends on completion of task A of project 1, task F of project 1 depends on completion of task D and task E of project 1; etc. Specification may also include different resource scenarios for each activity in the project, i.e. different resource staffing levels and the corresponding different activity durations.

At 206, resource allocation is performed using optimization allocation rules. Resource allocation utilizes the available resource outlook from resource pool and resource specification related to multiple projects from 204. Skill allocation may consider skill pool 218 specification that describes available head count for each (primary) skills and admissible substitution rule, e.g., substitute[SK1]={SK3}. Bill of resources describe skill requirement for each task and resource scenarios, e.g., different skills requirement with different task duration. Resource allocation for the current time frame is derived using an optimization problem in two scales, i.e., staffing and planning, that minimizes total project duration, minimizes cost associated to resource usage, and penalizes substitution and excessive under-utilization of resources. One of the outputs of the optimization tells to staff all tasks that must start in the next certain periods (staffing duration from t to t+Hs), that is indicated at 208. Another output 212 is to create aggregated skill requirement for the rest of the planning period (planning duration from t+Hs to t+H). At 208, the skill pool will be updated for allocated resources, i.e., those skill-types that are committed to specific activities that get scheduled in the short term, i.e., from t to t+Hs. These resources/skill-types are marked as committed. At 210, each project manager will schedule their activities that start in [t, t+Hs] using allocated skills from 208. Parallelly or simultaneously, the resource acquisition manager will take the aggregated resource request, the second output 212 from 206, compare with the available skill outlook for periods [t+Hs, t+H] from skill pool record 218 and create resource action plan 214 for hiring, contracting and cross-training. At 216, the action plan is executed and change in the skill outlook 218 is made. In one aspect, the skill pool 218 plays a role as a bookkeeping system. It provides information about different skill types, hiring and training history. Its records can be updated after some skills are assigned to some activities starting in the short-term. These skills are marked as “in-use” until completion of these activities. Its records can also be updated after execution of resource actions. At time period t=t+Hs shown at 220, we reach another evaluation (reviewing) point, and enter the next cycle of allocation and acquisition process.

The following describes the optimization model in one embodiment in detail.

### Programming Formulation

The program formulation in one embodiment may be addressed in two phases. In one or first phase, we formulate a multi-period optimization problem that involves two time scales. For a short-scale or the staffing period, the solution gives the chosen resource staffing level and different skills are assigned for near term. For a long-scale or the planning period, the solution gives the planned staffing level for activities in all projects beyond the short-term horizon. In another or second phase, we formulate another multi-optimization problem to address resource action planning. Based on the nature of shortage and overage, the solution gives a plan for hiring, contracting and cross-training different skill-types.

### Notations

The following are parameters or input data.
H: Total considered time horizon.
Hₛ: Time horizon for staffing, i.e. short-term horizon.
α[t]: Discount factor associated with time period t.
Sₚ: Set of projects.
Sₐ: Set of activities.
Sₒ[j]: Set of options for activities j. Each option is a specific staffing-level.
Sₚᵣₑ[j]: Set of activities that are predecessor of activities j.
Sₐₚ[p]: Set of activities that belong to the project p.
Sₛ: Set of skill-types.
Sᵣₑₚ[m]: Set of skill-types that are substituted types for skill-type m.
Rₛ[j, o, m]: Required amount of skill-type m for activity j with option o.
Rᵢ[m]: Initial available amount of skill-type m.
Cᵢ[m]: Usage cost of skill-type m.
D[j,o]: The duration for activity j with option o.
Tₑₛ[p]: Earliest start period of project p.
Tₗₛ[p]: Latest start period of project p.
T_{lf}[p]: Latest finish period of project s.
β: Percentage in a skill-type that can be used for substitution.

The following are to be determined variables (decision).
Z[j,o]: Binary, whether the activity j with option o is chosen.
X[j,o,t]: Binary, whether the activity j with option o is actively staffed at period t.
Y[p,t]: Binary, whether the project p has ongoing activities in time period t.
ZV[j,o]: Binary, whether the activity j with option o is chosen for staffing.
XV[j,o,t]: Binary, whether the activity j with option o is actively staffed at period t.
U[m,n,t]: Amount of skill in skill type n is substituted by skill type m at period t.
R[m,t]: Actual amount of skill with type m is available at period i.

The difference between X[j,o,t] and XV[j,o,t] is that XV[j,o,t] is used for staffing horizon and X[j,o,t] is for whole horizon. The whole horizon may include both short term and long term from t to t+H. A similar interpretation holds true for Z[j,o] and ZV[j,o].

### Objective Function

An example of the objective function is a weighted summation, written as the following. The first term of the function is for minimizing the total duration. All projects are finished as early as possible since the sum of projects at each period is divided by α[t]. The second term penalizes the discontinuity of activities. The third term minimizes cost associated to resource usage. The fourth term penalizes skill substitution. Substitution in earlier time periods would be penalized more due to the factor α[t]. The fifth term penalizes excess workforce and increasing resource utilization. Excess workforce at earlier periods gets more penalization.

$$min \{ \begin{matrix}\begin{matrix}\begin{matrix}{w}_{d} {\sum }_{t = 1}^{H} {\sum }_{p ∈ {S}_{p}} Y [ p ] / α [ t ] + {w}_{a} {\sum }_{i = 1}^{H} {\sum }_{j ∈ {S}_{a}} {\sum }_{o ∈ {S}_{o} [ j ]} X [ j , o , t ] / α ( t ) + \\ {w}_{c} {\sum }_{t = 1}^{H} {\sum }_{j ∈ {S}_{a}} {\sum }_{o ∈ {S}_{o} [ j ]} {\sum }_{m ∈ {S}_{s}} C [ m ] \cdot X [ j , o , t ] \cdot {R}_{s} [ j , o , m ] / α [ t ] +\end{matrix} \\ {w}_{s} {\sum }_{t = 1}^{{H}_{p}} {\sum }_{m ∈ {S}_{s}} {\sum }_{n ∈ {S}_{s}} U [ m , n , t ] \cdot α [ t ] +\end{matrix} \\ {w}_{e} {\sum }_{t = 1}^{{H}_{p}} {\sum }_{m ∈ {S}_{s}} ( R [ m , t ] - {\sum }_{j ∈ {S}_{t}} {\sum }_{o ∈ {S}_{o} [ j ]} x [ j , o , t ] \cdot {R}_{s} [ j , o , m ] ) \cdot α [ t ]\end{matrix} \} \}$$

Constraint from Activities Dependency

An activity cannot start until all activities that are predecessors of the activity finish. By the same token, an activity should finish before all activities that are successors of the activity. Mathematically, that is translated into the following. For each activity j, and each activity k that is a predecessor of the activity j (kεSₚᵣₑ[j]), for given period t, we have

$${\sum }_{o ∈ {S}_{o} [ j ]} X [ j , o , t ] <= {\sum }_{{o}^{′} ∈ {S}_{o} [ k ]} {\sum }_{s = 1}^{t - D [ k , {o}^{′} ]} X [ k , {o}^{′} , s ] {\sum }_{o ∈ {S}_{o} [ k ]} X [ k , o , t ] <= {\sum }_{{o}^{′} ∈ {S}_{o} [ j ]} {\sum }_{s = t + D [ j , {o}^{′} ]} X [ j , {o}^{′} , s ] \\ {\sum }_{o ∈ {S}_{o} [ j ]} X [ j , o , t ] + {\sum }_{{o}^{′} ∈ {S}_{o} [ k ]} X [ k , {o}^{′} , t ] <= 1. \qquad ( C 1 )$$

For each activity j, we have

$${\sum }_{o ∈ {S}_{o} [ j ]} Z [ j , o ] = 1 \\ \begin{matrix}{\sum }_{t = 1}^{H} X [ j , o , t ] = D [ j , o ] \cdot Z [ j , o ] & ∀ o ∈ {S}_{o} [ j ] .\end{matrix} \qquad ( C2 )$$

The first equation in (C2) means that, for each activity, one option is chosen, since we have multiple resource scenarios and each activity could be staffed in different levels. For instance, 2 java programmers and 1 architect would take 3 weeks to accomplish the activity, while 3 java programmers and 1 architect would take 2 weeks for the same activity. The second equation in (C2) is for the activity duration. For the chosen option, the s-urn of active periods for given activity is equal to the specified duration.

Constraint for Project Schedule

The earliest start, latest start and latest finish for each project can be expressed as the following. For each project p, we have

$${\sum }_{t = 1}^{{T}_{es} - 1} {\sum }_{j ∈ {S}_{ap} [ p ]} {\sum }_{o ∈ {S}_{o} [ j ]} X [ j , o , t ] = 0 \\ {\sum }_{t = {T}_{es}}^{{T}_{ls}} {\sum }_{j ∈ {S}_{ap} [ p ]} {\sum }_{o ∈ {S}_{o} [ j ]} X [ j , o , t ] \geq 1 \\ {\sum }_{t = {T}_{if} + 1}^{H} {\sum }_{j ∈ {S}_{ap}} {\sum }_{o ∈ {S}_{o} [ j ]} X [ j , o , t ] = 0. \qquad ( C 3 )$$

The first statement in (C3) specifies no activities are allowed before the earliest start date. The second statement specifies at least one activity happens between the earliest start and latest start dates. The third statement specifies no activities are allowed after the latest finish date. Further, the following constraints track whether a project is active in any given time period, t. For each project p and time period t,

$${\sum }_{j ∈ {S}_{ap} [ p ]} {\sum }_{o ∈ {S}_{o} [ j ]} X [ j , o , t ] \leq M \cdot Y [ p , t ] \\ Y [ p , t ] \leq {\sum }_{j ∈ {S}_{ap} [ p ]} {\sum }_{o ∈ {S}_{o} [ j ]} X [ j , o , t ] . \qquad ( C 4 )$$

The parameter M is a positive number, which is chosen to be the number of activities in all projects. This first constraint of (C4) guarantees that Y[p,t] is nonzero when there is at least one activity in period t. The second constraint guarantees that Y[p,t] is zero if there is no ongoing activity in period t for project p.

### Tracking Variable for Short-Term Activities

In order to specify resource constraints for activities that are staffed over the short-term time scale, we introduce variables XV and ZV that are used to track these activities. For each activity j, option oεSₒ[j], the variable ZV[j,o] satisfies the following

$${\sum }_{t = 1}^{{H}_{s}} X [ j , o , t ] \leq {H}_{s} \cdot ZV [ j , o ] \\ ZV [ j , o ] \leq {\sum }_{t = 1}^{{H}_{s}} X [ j , o , t ] . \qquad ( C5 )$$

Similar to Y[p,t], the first term in (C5) guarantees that ZV[j,o] is nonzero if there are any activities ongoing during the short-term horizon; the second term guarantees that ZV[j,o] is zero if no activity happens during the staffing period.

For tracking variable XV, we linearize the product of two binary variables, namely X and ZV. For each activity j, option oεSₒ[j] and period t, the XV[j,o,t] satisfy the following,

XV[j,o,t]≦X[j,o,t]

X[j,o,t]≦ZV[j,o]

XV[j,o,t]≧X[j,o,t]+ZV[j,o]−1. (C6)

That guarantees that, XV[j,o,t] will be zero if either X[j,o,t] or ZV[j,o] is zero, and XV[j,o,t] will be non-zero if both X[j,o,t]and ZV[j,o]are non-zero.

### Resource Constraint

The actual resource availability of each skill will change from period to period due to the substitutability among skills types. Mathematically, for each skill m and time-period t, we have the following,

$$R [ m , t ] = {R}_{i} [ m ] + {\sum }_{s = 1}^{t} {\sum }_{n ∈ {S}_{s}} U [ n , m , s ] - {\sum }_{s = 1}^{t} {\sum }_{n ∈ {S}_{s}} U [ n , m , s ] . \qquad ( C7 )$$

The first term on the right hand side of equation (C7) is the initial availability, the second term is the amount of skills that gets transferred into skill type m from 1 to t, and the third term is the amount of skills that gets transferred out to other skill types from skill type m, for 1 to t. The assigned resource during the short-term period should satisfy the corresponding actual availability of the resource. Further, whenever the activities start within and extend beyond the short-term horizon, the resource constraint is also met beyond the short-term horizon period. That is guaranteed through the following, for each time period t,

$${\sum }_{j ∈ {S}_{a}} {\sum }_{o ∈ {S}_{o} [ j ]} XV [ j , o , t ] \cdot {R}_{s} [ j , o , m ] \leq R [ m , t ] . \qquad ( C 8 )$$

Note that, the sum on the left hand side of equation (C8) only covers activities starting in the short-term period, since the XV is used instead of X.

The substitutable amount among skill types satisfies the requirement as follows. For each skill type m, and time period t, we have

$${\sum }_{n ∈ {S}_{res} [ m ]} U [ m , n , t ] \leq β \cdot R [ m , t ] \\ \begin{matrix}U [ m , n , t ] = 0 & ∀ n ∉ {S}_{rep} [ m ] and t \leq {H}_{s}\end{matrix} \\ \begin{matrix}U [ m , n , t ] = 0 & ∀ n and t > {H}_{s} .\end{matrix} \qquad ( C9 )$$

The first equation in (C9) specifies how much can be substituted out from skill type m at time period t. The second equation in (C9) specifies that the amount substituted from skill type m to n is zero if not substitutable. The third equation in (C9) indicates that, substitutability does not apply beyond the short-term horizon.

### Resource Action Planning for Long-Term

The second phase of the model aggregates the resource requirement from the planned staffing-level for all activities in long-term. For each skill-type m and time period t, the quantity

$${\sum }_{j ∈ {S}_{a}} {\sum }_{o ∈ {S}_{o} [ j ]} ( X [ j , o , t ] - XV [ j , o , t ] ) \cdot {R}_{s} [ j , o , m ]$$

represents the aggregate resource requirement beyond the short-term horizon. In one aspect, we exclude the resources staffed for activities that start in the short-term horizon, since resources that are assigned to activities in short-term horizon, are committed for accomplishing these activities. The activities with allocated resources would not submit further resource requests, unless there is a scope-change in these activities. Combining this with information about lead time and cost of hiring, contracting and cross-training, we solve another optimization problem described in D. Subramanian and L. An, “Optimal Resource Action Planning Analytics for Services Business Using Hiring, Contracting and Cross-Training of Various Skills”, 2008 IEEE International Conference on Services Computing (SCC 2008), Honolulu, Hi., July, 2008. The formulation takes all operational and system constraints and business rules into consideration. By solving the problem, we obtain an optimal solution for hiring, contracting and cross-training in different skill types to cover the incoming engagement resource requirement (future staffing-level decisions). The resource acquisition manager may then execute the plan to adjust the available workforce pool with different skill types.

An integrated model of the present disclosure in one embodiment addresses short-term staffing and long-term resource action planning for an upcoming engagement portfolio. The linear and integer programming model incorporates resource flexibility from each project—staffing level and schedule, short-term substitutability among skill types, long-term resource action planning—e.g., hiring, contracting and cross-training for resources. The model strives for total duration minimization, resource cost minimization The solution meets the various kinds of constraints, like availability of different skill-types in the staffing period, business rules and operational limitation for resource action etc.

Various aspects of the present disclosure may be embodied as a program, software, or computer instructions embodied in a computer or machine usable or readable medium, which causes the computer or machine to perform the steps of the method when executed on the computer, processor, and/or machine.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A computer-implemented method for integrated short-term activity resource staffing levels and long-term resource action planning for a portfolio of services projects, comprising:
establishing short-term resource-staffing level for each project activity in a portfolio of services projects subject to short-term resource availability in each skill type and substitutability among skill types;
establishing long-term resource-staffing level; and
establishing long-term resource action planning to meet the long-term resource-staffing level using combination of a plurality of resource actions.

2. The method of claim 1, wherein the plurality of resource actions includes at least hiring, contracting, and cross-training.

3. The method of claim 1, wherein the step of establishing short-term resource-staffing level includes transferring skills from one project to another project in the portfolio of services projects.

4. The method of claim 1, wherein the step of establishing short-term resource-staffing level includes substituting skill types.

5. The method of claim 1, wherein the steps of establishing use two-time-scale optimization formulation for immediate and non-immediate activities.

6. The method of claim 1, wherein the step of establishing long-term resource action planning includes planning subject to minimum residence time a resource unit needs to spend in a skill-type that it gets cross-trained or hired into, minimum acceptable contracting duration for a contracted skill type, first order and higher orders of cross-training for a skill type with lead-time for training, system rules on permissible transfers, targets on service levels and resource utilization, or combinations thereof.

7. The method of claim 1, wherein the step of establishing long-term resource action planning includes planning subject to gap minimization, glut minimization, cost minimization with demand fulfillment constraints, and weighted combinations thereof.

8. The method of claim 1, wherein the step of establishing long-term resource action planning includes planning subject to a stochastic extension for a risk-measure on gap or glut due to uncertainties in the demand profile.

9. The method of claim 1, wherein the step of establishing short-term resource-staffing level uses a mathematical optimization model with constraints including at least availability of resources of each skill-type, precedence structure within each project, and earliest start and latest finish constraints for each project.

10. The method of claim 1, wherein the steps of establishing includes formulating an objective function that minimizes total cost resulting from accumulated gaps and gluts for each skill type, hiring, contracting and cross-training costs.

11. The method of claim 1, wherein the steps of establishing includes simultaneously solving an objective function that minimizes total cost resulting from accumulated gaps and gluts for each skill type, hiring, contracting and cross-training costs.

12. The method of claim 11, wherein the objective function comprises:
resource-staffing level optimization problem that determines the short-term resource-staffing level and the long-term resource-staffing level, the long-term resource-staffing level including a demand profile for each skill type over long-term; and
resource-action planning problem for determining the plurality of resource actions based on the demand profile and minimum residence time that a resource unit spends in a skill type that it gets cross-trained into or hired into, minimum acceptable contracting duration for a contracted skill type, first order and higher orders of cross-training for a skill type with lead-time and cost for training, system rules on permissible transfer sequences, targets on service levels and resource utilization.

13. The method of claim 1, wherein the steps of establishing includes simultaneously solving an objective function that includes a weighted summation including a first term that minimizes total duration of all projects in the portfolio of services projects, a second term that penalizes discontinuity of activities, a third term that minimizes cost associated with resource usage, a fourth term that penalizes skill substitution, and a fifth term that penalizes excess workforce and increase in resource utilization.

14. The method of claim 13, wherein the fourth term penalizes skill substitution in earlier time periods more that skill substitution in later time periods of a project duration.

15. The method of claim 13, wherein the fifth term expresses penalizing excess workforce occurring at earlier periods than occurring at later periods of a project duration.

16. The method of claim 13, wherein the objective function minimizes cost and duration subject to dependency constraints among each project activities.

17. The method of claim 13, wherein the objective function minimizes cost and duration subject to project schedule constraint including at least earliest start, latest start and latest finish time frames for said each project activity.

18. A system for integrated short-term activity resource staffing levels and long-term resource action planning for a portfolio of services projects, comprising:
a computer-implemented resource-staffing module operable to establish short-term resource-staffing level for each project activity in a portfolio of services projects subject to short-term resource availability in each skill type and substitutability among skill types and further operable to establish long-term resource-staffing level; and
a computer-implemented resource action planning module operable to establish long-term resource action planning to meet the long-term resource-staffing level using combination of a plurality of resource actions

19. A program storage device readable by a machine, tangibly embodying a program of instructions executable by the machine to perform a method for integrated short-term activity resource staffing levels and long-term resource action planning for a portfolio of services projects, comprising:
establishing short-term resource-staffing level for each project activity in a portfolio of services projects subject to short-term resource availability in each skill type and substitutability among skill types;
establishing long-term resource-staffing level; and
establishing long-term resource action planning to meet the long-term resource-staffing level using combination of a plurality of resource actions.

20. The program storage device of claim 19, wherein the steps of establishing includes simultaneously solving an objective function that includes a weighted summation including a first term that minimizes total duration of all projects in the portfolio of services projects, a second term that penalizes discontinuity of activities, a third term that minimizes cost associated with resource usage, a fourth term that penalizes skill substitution, and a fifth term that penalizes excess workforce and increase in resource utilization.
